(19) United States
(12) Patent Application Publication
(10) Pub. No.: US 2004/0190524 A1
(43) Pub. Date: Sep. 30, 2004

(54) Scheduler device for a system having asymmetrically-shared resources

(75) Inventors: Prasad Golla, Plano, TX (US); Emmanuel Dotaro, Verrieres Le Buisson (FR); Laurent Ciavaglia, Fontainebleau (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/669,648

(22) Filed: Sep. 25, 2003

(30) Foreign Application Priority Data
Sep. 26, 2002 (FR) 02 11 899

(51) Int. Cl. H04L 12/28

(52) U.S. Cl. 370/395.4

(57) ABSTRACT

The present invention relates to a scheduler, also referred to as a service discipline, for a system comprising a plurality of nodes sharing a plurality of resources such as wavelengths. The scheduler 2 of the invention schedules the transmission of data from a plurality of queues B₁, B₂, and B₃ from a source node 1 to a plurality of destination nodes N₁, N₂, and N₃ via a plurality of outlet ports P₁, P₂, P₃, and P₄ from said source node 1, each of said outlet ports P₁, P₂, P₃, and P₄ being associated with a resource OR₁, OR₂, OR₃, and OR₄, the data being transmitted via said resource to a destination node N₁, N₂, and N₃, each of said nodes receiving data from all or some of said plurality of resources OR₁, OR₂, OR₃, and OR₄. The scheduler device 2 is characterized in that it comprises a plurality of servers S₁, S₂, S₃, and S₄, each of said servers being associated with a respective one of said resources of said plurality of resources OR₁, OR₂, OR₃, and OR₄, and each of said servers comprising scheduler means, said scheduler means being independent for each of said servers.

The present invention relates to a scheduler, also referred to as service discipline, for a system that comprises a plurality of nodes sharing a plurality of resources such as wavelengths.

Such a system is constituted, for example, by an optical packet ring network of the dual bus optical ring network (DBORN) type. The architecture of the ring is organized around a concentrator and is constituted by a plurality of nodes such as optical packet add/drop multiplexers (OPADMs), each node being in communication with the concentrator. The network contains a write bus corresponding to a plurality of “up” wavelengths and a read bus corresponding to a plurality of “down” wavelengths. The up and down wavelengths are usually multiplexed on the same fiber and are used and thus shared by the nodes of the network for sending and receiving packets to and from the concentrator. A plurality of nodes thus share a common resource such as a wavelength for receiving packets sent by the concentrator which can be considered as source node.

However, in order to take account of the specific features of each node, all of the nodes do not necessarily share the same resources. Thus, it can happen that a resource is shared by a fraction only of the nodes of the network.

Since each of the nodes does not share the same resources as the other nodes in the same proportions, the resources are said to be shared asymmetrically.

One of the functions of networks relates to service discipline, i.e. the fact of determining amongst a plurality of waiting queues or buffers, which packet associated with a position queue is to be sent over a node. This determination is performed by a device referred to as a scheduler.

The present invention provides a scheduler device, also known as service discipline, for a system comprising a plurality of nodes that share a plurality of resource such as wavelengths in asymmetric manner.

To this end, the present invention provides a scheduler device for scheduling the transmission of data from a plurality of queues in a source node to a plurality of destination nodes via a plurality of outlet ports from said source node, each of said outlet ports being associated with a resource, the data being transmitted via said resource to said destination node, each of said nodes receiving data from all or some of said plurality of resources, said scheduler device being characterized in that it has a plurality of servers, each of said servers being associated with a respective one of the resources of said plurality of resources and each of said servers including scheduler means, said scheduler means being independent for each of said servers.

By means of the invention, each server operates independently of the other servers and can take account of the specific features of the resource with which it is associated, and in particular the fact that a resource is not shared uniformly by all of the destination nodes, each node making use of said resource with a certain weighting coefficient. This weighting coefficient may be zero if the node does not use said resource. The coefficient may itself be weighted depending on the importance of that resource for the destination node. Thus, a resource that is used by a first node and by a second node is not shared in the same manner by the first node and the second node if the first node makes use of more other resources than does the second node. For example, each server can take two weights into consideration: a first weight providing information about the use of the resource by the node and representing the asymmetry of the system; and a second weight giving information about the ratio with which that resource is used by the node as a function of the traffic destined for said node relative to the total traffic.

In an embodiment, said scheduler means comprise a plurality of stages corresponding respectively to a plurality of scheduling schemes using different criteria.

In an embodiment, said scheduling means comprise cyclical scheduling means of the round robin type.

The round robin scheduler means scan sequentially and cyclically the first-in first-out (FIFO) type queues and serve the first non-empty queue that is ready. If a queue is empty, then the scheduler means move onto the following queue. Some queues may be privileged by defining a weight, corresponding, for example, to the number of elements or packets that the scheduler may take from the head of the queue; this is referred to as a weighed round robin (WRR).

In another embodiment, said scheduler means include weighted fair queuing (WFQ) scheduler means.

This algorithm gives priority treatment to low volume flows and enables large volume flows to make use of the remaining space. For this purpose, it sorts and regroups packets by flow, and then puts them into queues depending on the volume of traffic in each flow.

Advantageously, said scheduler means depend on a static and/or dynamic set of weights.

By way of example, the static weights may come from conventional methods of sharing or allocating resources. The dynamic weights may be calculated on the basis of congestion control information. A combination of these two types of weighting can also be envisaged.

In a particularly advantageous embodiment, said scheduler means depend on a first set of weights, each of said weights representing the percentage of said resource allocated to each of said nodes in said plurality of nodes.

This type of weighting is obtained by conventional resource sharing or allocation methods.

Advantageously, said scheduler means depend on a second set of weights, each of said weights representing the relative weight of the traffic of each of said nodes relative to the total traffic.

The present invention also provides a node including a scheduler device of the invention and having a plurality of queues for sending data to a plurality of destination nodes, and a plurality of outlet ports.

The invention also provides a data transmission system comprising at least source node of the invention, said system further comprising:

a plurality of destination nodes; and

a plurality of resources.

Other characteristics and advantages of the present invention appear from the following description of an embodiment of the invention, given by way of non-limiting illustration. In the figures:

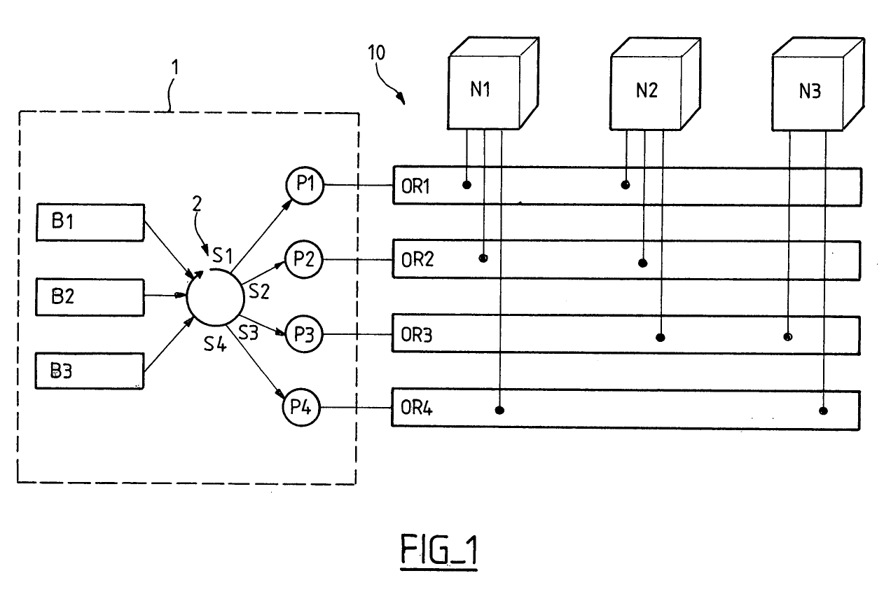

FIG. 1 is a diagram of a transmission system incorporating a first embodiment of the scheduler device of the invention;

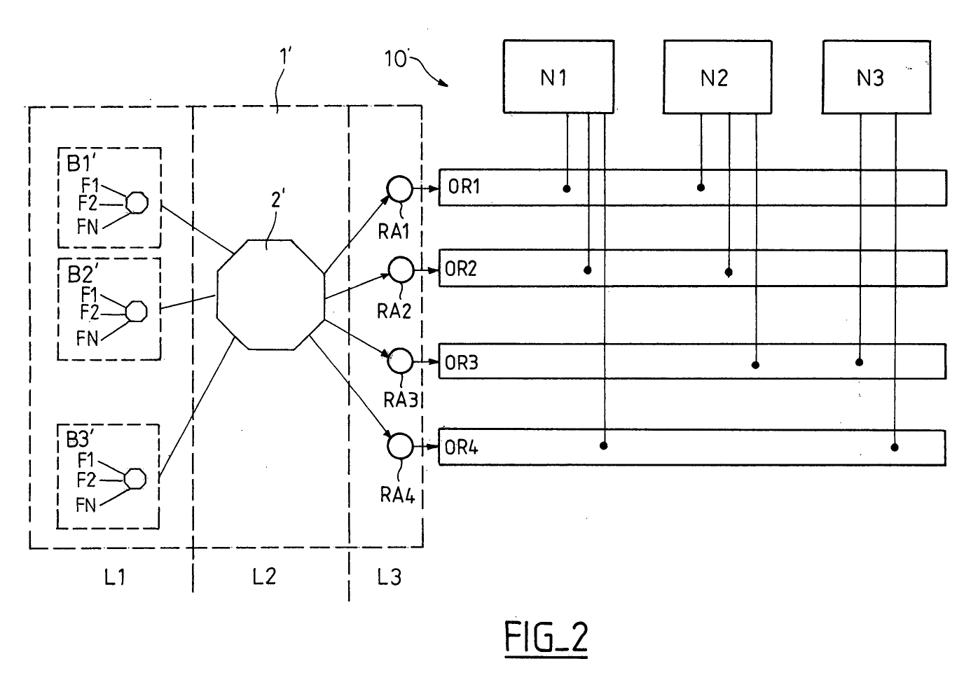

FIG. 2 is a diagram of a transmission system incorporating a second embodiment of the scheduler device of the invention; and

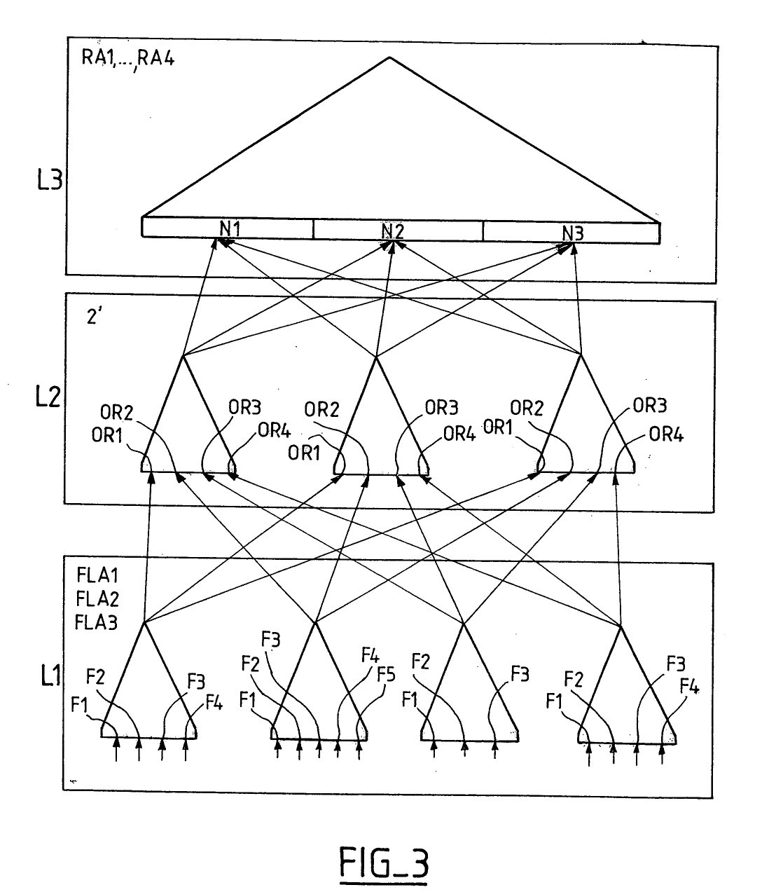

FIG. 3 illustrates three-level arbitration.

FIG. 1 is a diagram of a transmission system 10 such as an optical packet ring network. This representation is restricted to describing the invention, and the system may have numerous other elements. The system 10 comprises:

a source node 1;

three destination nodes N₁, N₂, and N₃; and

four resources OR₁, OR₂, OR₃, and OR₄.

By way of example, the resources OR₁, OR₂, OR₃, and OR₄ are wavelengths multiplexed on an optical fiber using a dense wavelength division multiplex (DWDM) technique.

By way of example, the nodes N₁, N₂, and N₃ are optical packet add/drop multiplexers (OPADMs).

By way of example, the source node 1 is an electronic concentrator such as an Ethernet switch.

The source node 1 comprises:

three queues or buffers B₁, B₂, and B₃ enabling packets to be stored before sending them respectively to the nodes N₁, N₂, and N₃;

a scheduler device 2 also referred to as service discipline; and

four outlet ports P₁, P₂, P₃, and P₄ enabling data packets to be sent respectively over the resources OR₁, OR₂, OR₃, and OR₄.

The scheduler device 2 comprises four servers S₁, S₂, S₃, and S₄ each associated with a respective one of the resources OR₁, OR₂, OR₃, and OR₄ and with a respective one of the ports P1, P₂, P₃, and P₄.

Each of the four servers S₁, S₂, S₃, and S₄ determines which packet associated with a particular queue is to be sent to a node via the resource associated with the server.

The resources OR₁ and OR₂ are shared by the nodes N₁ and N₂.

The resource OR₃ is shared by the nodes N₂ and N₃.

The resource OR₄ is shared by the nodes N₁ and N₃.

The resources are thus not shared uniformly by the nodes N₁, N₂, and N₃.

Thus, a single resource used by a first node and by a second node need not be used in the same manner, with the first node making use of more other resources than the second node.

For example, the node N₁ uses the resources OR₁, OR₂, and OR₄, while the node N₃ uses only the resources OR₃ and OR₄. The node N₁ can therefore use three resources while the node N₃ can use only two.

The resource allocation method thus takes account of this non-uniformly distributed allocation and gives each of the nodes a weight corresponding to the percentage of the allocation of said resource to each of said nodes in said plurality of nodes. This weighting is written in general manner as Rᵢⱼ and corresponds to the ratio allocated to node Nᵢ of resource ORⱼ.

In addition, the destination nodes may have weights that are different because of their traffic. Thus, if the traffic destined for node Nᵢ is written Tᵢ, then each node may be weighted by a coefficient Wᵢ equal to (Tᵢ/ΣᵢTᵢ) where ΣᵢTᵢ designates the sum of the traffic to all of the nodes.

Thus, each of the servers is given a series of weights referred to as “meta-weights” for each of the nodes taking account both of the asymmetrical sharing of the resources and the differing amounts of traffic for each of the nodes.

These meta-weights are summarized in Table 1 below and each corresponds to the product of Rᵢⱼ multiplied by Wᵢ.

TABLE 1

| | Servers/nodes | | |
|---|---|---|---|
| | N₁ | N₂ | N₃ |
| S₁ | W₁ × R₁₁ | W₂ × R₂₁ | W₃ × R₃₁ |
| S₂ | W₁ × R₁₂ | W₂ × R₂₂ | W₃ × R₃₂ |
| S₃ | W₁ × R₁₃ | W₂ × R₂₃ | W₃ × R₃₃ |
| S₄ | W₁ × R₁₄ | W₂ × R₂₄ | W₃ × R₃₄ |

Each of said servers uses these meta-weights and proceeds independently of the other servers with a round robin type scheduling mechanism of the round robin type, of the weighted round robin (WRR) type, or of the weighted fair queuing (WFQ) type in order to select the queue and the packet(s) to be sent. The servers may comprise software means, hardware means, or a combination of both.

The weights as described above can be updated statically or dynamically. Dynamic updating enables scheduling to adapt dynamically by taking account of variation in loading as a function of time and of destination.

In addition, the invention makes it possible to keep packets in order by eliminating any need for complex and expensive mechanisms or procedures for mitigating the consequences of loss of sequencing and for reorganizing packets. In order to ensure that packets are kept in order, it suffices that packet servicing complies with the established order by means of the servers making use of packet by packet parallel access (and not block access).

The invention is described above with reference to a set of weights representing the relative weights of traffic for each of the nodes compared with the total traffic, but other sets of weights may be used representing other parameters or characteristics of each of the nodes, such as types of service and/or of user. The weights may be applied in the form of meta-weights, as described above, but they can also be applied in the form of parameters that are separated in different levels.

FIG. 2 is a diagram of a transmission system incorporating a second embodiment of the scheduler device of the invention, having a plurality of stages L₁, L₂, L₃ corresponding respectively to a plurality of scheduling operations using different criteria. The network 10′ is analogous to the network 10 described above. It differs in its scheduler device in the source node 1′, and it comprises:

three queues or buffers B′₁, B′₂, and B′₃ serving to store packets before sending them respectively to the nodes N₁, N₂, and N₃, each of these queues being provided with a flow level scheduler respectively referenced FLA₁, FLA₂, FLA₃ to arbitrate between the flows F₁, . . . , F_{N} each heading for the same outlet from the node 1′;

a node level scheduler device 2′ which arbitrates between loads corresponding respectively to the different destinations as a function of bus capacities; and

four resource level scheduler devices RA₁, RA₂, RA₃, and RA₄ serving to take account of the way in which the nodes N₁, . . . , N₄ are connected to the resources OR₁, OR₂, OR₃, and OR₄.

FIG. 3 illustrates this three-level arbitration implemented in the scheduler device of node 1′ as shown in FIG. 2.

Naturally, the invention is not limited to the embodiments described above. In particular, the number of hierarchical levels may be greater than three.

Specifically, the invention is described above in the context of an optical packet network, however it can be generalized to any type of system using resources that are shared asymmetrically, such as a computer system having a plurality of memory units (queues) connected to a plurality of processors (servers) via a plurality of resources (electronic circuits) organized as a read and write bus, the source node designating an individual component having said plurality of memory units.

Similarly, the scheduling mechanisms may be different from those described.

1. A scheduler device (2) for scheduling the transmission of data from a plurality of queues (B₁, B₂, B₃) in a source node (1) to a plurality of destination nodes (N₁, N₂, N₃) via a plurality of outlet ports (P₁, P₂, P₃, P₄) from said source node (1), each of said outlet ports (P₁, P₂, P₃, P₄) being associated with a resource (OR₁, OR₂, OR₃, OR₄), the data being transmitted via said resource to said destination node (N₁, N₂, N₃), each of said nodes receiving data from all or some of said plurality of resources (OR₁, OR₂, OR₃, OR₄), said scheduler device (2) being characterized in that it has a plurality of servers (S₁, S₂, S₃, S₄), each of said servers being associated with a respective one of the resources of said plurality of resources (OR₁, OR₂, OR₃, OR₄) and each of said servers including scheduler means, said scheduler means being independent for each of said servers.

2. A scheduler device (2) according to claim 1, characterized in that said scheduler means comprise a plurality of stages (L₁, L₂, L₃) corresponding respectively to a plurality of scheduling schemes using different criteria.

3. A scheduler device (2) according to claim 1, characterized in that said scheduling means comprise cyclical scheduling means of the round robin type.

4. A scheduler device (2) according to claim 1, characterized in that said scheduling means comprise weighted fair queuing (WFR) scheduling means.

5. A scheduler device (2) according to claim 1, characterized in that said scheduling means are dependent on a set of static and/or dynamic weights.

6. A scheduler device (2) according to claim 1, characterized in that said scheduler means are dependent on a first set of weights, each of said weights representing the percentage of said resource allocated to each of said nodes of said plurality of nodes.

7. A scheduler device (2) according to claim 5, characterized in that said scheduler means depend on a second set of weights, each of said weights representing the relative weight of the traffic of each of said nodes relative to the total traffic of the plurality of said nodes.

8. A node (1) including a scheduler device (2) according to claim 1, the node comprising a plurality of queues (B₁, B₂, B₃) for sending data to a plurality of destination nodes (N₁, N₂, N₃), and a plurality of outlet ports (P₁, P₂, P₃, P₄).

9. A data transmission system (10) including at least one source node (1) according to any preceding claim claim 1.
